(19) United States
(12) Patent Application Publication
(10) Pub. No.: US 2026/0207010 A1
(43) Pub. Date: Jul. 23, 2026

(54) COCKTAIL SHAKER WITH MOVABLE COVER

(71) Applicant: Speed Tin LLC, Wall, NJ (US)

(72) Inventors: David Quisumbing, Wall, NJ (US); Jonas CONCEPCION, Beacon, NY (US)

(21) Appl. No.: 19/139,460

(22) PCT Filed: Nov. 20, 2024
(86) PCT No.: PCT/US2024/056583

§ 371 Date: Jun. 16, 2025

Related U.S. Application Data
(63) Continuation of application No. 18/636,834, filed on Apr. 16, 2024, now Pat. No. 12,256,867.
(60) Provisional application No. 63/601,614, filed on Nov. 21, 2023.

(51) Int. Cl. A47J 43/27; A47G 19/22; B65D 47/28

(52) U.S. Cl. CPC A47J 43/27; A47G 19/2272; B65D 47/286; B65D 2543/00046

(57) ABSTRACT

A cocktail shaker includes a cup for receiving liquid ingredients, and a lid for installing on the cup. The lid includes a base including a top wall, an opening in the top wall for dispensing the liquid ingredients out of the cocktail shaker, and a pressure relief hole in the top wall for releasing air from the cup while dispensing the liquid ingredients out of the cocktail shaker through the opening. The lid also includes a cover movably coupled to the base for moving along the top wall between a first orientation in which the cover covers the opening and the pressure relief hole, and a second orientation in which the opening and the pressure relief hole are uncovered. The cocktail shaker also includes an elastic element for biasing the cover into the first orientation.

The present disclosure relates to cocktail shakers.

### BACKGROUND

Conventional cocktails shakers include lids that include two separate pieces. A first larger piece is a cup-shaped and attaches to the base cup of the cocktail shaker. The first larger piece includes pour-holes for pouring cocktails into glasses. A second smaller piece is cup-shaped cover and is removably attachable to the top of the first larger piece to prevent the cocktail from spilling out of the pour-holes when the cocktail is being shaken by a bartender, but is removable to pour cocktails out of the pour-holes into glasses. This arrangement requires the bartender to use both hands to remove the second smaller piece before pouring a cocktail, and can result in the second smaller piece getting misplaced, while limiting the bartender's use of both hands.

### SUMMARY

A cocktail shaker and a cocktail shaker lid are provided that allow a bartender to use a single hand to shake and pour a cocktail. This allows the bartender to use to two cocktail shakers at the same time to shake and pour two cocktails at the same time-one with each hand-or to shake and pour a cocktail with one hand and use the other hand to clean up or perform other bartending activities.

A cocktail shaker is provided including a cup for receiving liquid ingredients; and a lid for installing on the cup, the lid including: a base including: a top wall; an opening in the top wall for dispensing the liquid ingredients out of the cocktail shaker; and a pressure relief hole in the top wall for releasing air from the cup while dispensing the liquid ingredients out of the cocktail shaker through the opening; a cover movably coupled to the base for moving along the top wall between a first orientation in which the cover covers the opening and the pressure relief hole, and a second orientation in which the opening and the pressure relief hole are uncovered; and an elastic element for biasing the cover into the first orientation, the cover being movable from the first orientation into the second orientation by overcoming the biasing by the elastic element, the cup and lid being configured such that a user can grip the cup with one hand and move the cover from the first orientation to the second orientation with an index finger of the one hand.

In examples, the elastic element is positioned above the top wall.

In examples, the elastic element is housed within the cover.

In examples, the elastic element is housed entirely within the cover.

In examples, an entirety of the cover is above the top wall during the movement from the first orientation into the second orientation.

In examples, the cover is configured for being snapped on and off of the base.

In examples, the cover is configured such that an upward force applied by a user's finger to a longitudinal end of the cover snaps the cover off of the base.

In examples, the cover includes guides on sides thereof that are configured for being snapped into engagement with lips on the base.

In examples, the base includes a longitudinally extending slot in which the cover is movable between the first orientation and the second orientation, the slot being delimited by two longitudinally extending side walls, the lips forming parts of tracks in the two longitudinally extending side walls.

In examples, cover includes a gasket configured for cover the opening and the pressure relief hole in the first orientation, the tracks each including an end section configured to interact with the respective guides to move the cover downward to force the gasket downward at the opening and at the pressure relief hole.

In examples, the guides are coupled to the cover for being temporarily biased into the cover during the snapping of the of the guides into engagement with the lips.

In examples, the base includes a longitudinally extending slot in which the cover is movable between the first orientation and the second orientation, the cover having a length L1 that is between 1.0 and 2.25 inches, and the slot having a length L2 that between 0.25 and 1.0 inch longer than the length L1 of the cover.

In examples, a maximum length L3 of a top of the lid, measured along the center of the slot, is between 1.3125 and 3.50 inches long.

In examples, a center of a top front edge of a finger grip of the cover is a length L4 of 0.25 to 1.0 inches from a frontmost edge of the cover.

In examples, the base includes: an annular section for coupling to a top edge of the cup; a retainer configured for connecting the cover to the top wall; and a frustoconical intermediate section connecting the annular section to the retainer.

In examples, a cocktail shaker, further including a stop fixed to the top wall, the elastic element being a spring held between the cover and the stop.

In examples, the elastic element is configured for being in an expanded orientation in the first orientation of the cover and in a contracted orientation in the second orientation of the cover, the elastic element configured to be compressed by moving the cover from the first orientation to the second orientation and compressing the elastic element between the stop and a surface of the cover.

In examples, the based includes a strainer is formed by a plurality of strips traversing the opening.

A cocktail shaker lid is also provided that is configured for being connected to a cup for receiving liquid ingredients to form a cocktail shaker, the lid including: a base including: an opening for dispensing the liquid ingredients out of the cocktail shaker; and a pressure relief hole for releasing air from the cup while dispensing the liquid ingredients out of the cocktail shaker through the opening; a cover movably coupled to the base for moving between a first orientation in which the cover covers the opening and the pressure relief hole, and a second orientation in which the opening and the pressure relief hole are uncovered; and an elastic element biasing the cover into the first orientation, the cover being movable from the first orientation into the second orientation by overcoming the biasing by the elastic element, the lid being configured such that a user can grip the lid with one hand and move the cover from the first orientation to the second orientation with an index finger of the one hand.

The cocktail shaker includes a cup for receiving liquid ingredients and a lid for installing on the cup. The lid includes a base including an opening for dispensing the liquid ingredients out of the cocktail shaker, and a pressure relief hole for releasing air from the cup while dispensing the liquid ingredients out of the cocktail shaker through the opening. The lid also includes a cover movably coupled to the base for moving between a first orientation in which the cover covers the opening and the pressure relief hole, and a second orientation in which the opening and the pressure relief hole are uncovered. The lid further includes at least one elastic element biasing the cover into the first orientation. The cover is movable from the first orientation into the second orientation by overcoming the biasing by the at least one elastic element.

In examples, the base includes: an annular section for coupling to a top edge of the cup; and a top wall including the opening and the pressure relief hole, the cover being slidably connected to the top wall.

In examples, the base further includes a retainer configured for connecting the cover to the top wall.

In examples, a first portion of the at least one elastic element is connected to the retainer and a second portion of the at least one elastic element is connected to the cover.

In examples, the at least one elastic element configured for being in an expanded orientation in the first orientation of the cover and in a contracted orientation in the second orientation of the cover, the at least one elastic element configured to be compressed by moving the cover from the first orientation to the second orientation.

In examples, the at least one elastic element configured for being in a contracted orientation in the first orientation of the cover and in an expanded orientation in the second orientation of the cover, the at least one elastic element configured to be expanded by moving the cover from the first orientation to the second orientation.

In examples, the at least one elastic element includes a first spring and a second spring, a first end of the first spring being connected to the cover and a second end of the first spring being connected to the retainer, a first end of the second spring being connected to the cover and a second end of the second spring being connected to the retainer.

In examples, the retainer defines a slot in which the cover is slidable between the first orientation and the second orientation.

In examples, the retainer includes a first lip on a first side of the slot and a second lip on a second side of the slot, the first and second lips configured for retaining the cover in the slot as the cover is slid between the first orientation and the second orientation.

In examples, the retainer includes a first section defining the first side of the slot and including the first lip, a second section defining the second side of the slot and including the second lip, and a third section defining a longitudinal end of the slot, the cover being movable toward the third section when moving from the first orientation to the second orientation.

In examples, the retainer includes a semi-circular outer perimeter when viewed from a top of the cocktail shaker, the semi-circular outer perimeter extending along the first section, the second section and the third section of the retainer.

In examples, the base further includes an inclined wall extending upward and away from the top wall, the inclined wall being at an obtuse angle with respect to the top wall.

In examples, the cover is slidably connected to the top wall for sliding parallel to the top wall.

In examples, the cover includes a finger grip for moving the cover from the first orientation to the second orientation.

In examples, the cover includes a sealing gasket for sealing the opening and the pressure relief hole in the first orientation.

In examples, the cocktail shaker further includes a strainer positioned below the opening, the strainer being configured to strain out ice from the liquid ingredients upon pouring of the liquid ingredients through the strainer and out of the opening.

In examples, the base includes an annular section configured for connecting to the cup, the strainer including a plate-shaped base configured for connecting to the annular section of the base, the plate-shaped base including a plurality of holes or slots formed therein.

A method of using the cocktail shaker sequentially includes filling the cup with the liquid ingredients; connecting the lid on top of the cup; shaking the cocktail shaker to mix the liquid ingredients; applying a force to the cover with a finger of a user to move the cover from the first orientation to the second orientation; pouring at least some of the liquid ingredients out of the opening into a glass while the cover is in the second orientation; and releasing the force applied to the cover to cause the elastic element to move the cover from the second orientation back into the first orientation.

A cocktail shaker lid configured for being connected to a cup for receiving liquid ingredients to form a cocktail shaker is also provided. The lid includes a base including an opening for dispensing the liquid ingredients out of the cocktail shaker, and a pressure relief hole for releasing air from the cup while dispensing the liquid ingredients out of the cocktail shaker through the opening. The lid also includes a cover movably coupled to the base for moving between a first orientation in which the cover covers the opening and the pressure relief hole, and a second orientation in which the opening and the pressure relief hole are uncovered. The lid further includes at least one elastic element biasing the cover into the first orientation. The cover is movable from the first orientation into the second orientation by overcoming the biasing by the at least one elastic element.

A method is also provided for manufacturing a cocktail shaker lid configured for being connected to a cup for receiving liquid ingredients to form a cocktail shaker. The method includes creating a base defining an opening for dispensing the liquid ingredients out of the cocktail shaker and a pressure relief hole for releasing air from the cup while dispensing the liquid ingredients out of the cocktail shaker through the opening; and creating an elastically loaded cover configured for being movably connected to the base, the elastic element loaded cover being biased into a first orientation in which the elastically loaded cover covers the opening and the pressure relief hole, the elastically loaded cover being movable from the first orientation into a second orientation in which the opening and the pressure relief hole are uncovered by a user applying a force with a finger of the user finger to overcome the elastically loading.

### BRIEF DESCRIPTION OF THE DRAWINGS

The present disclosure is described below by reference to the following drawings, in which:

FIG. 1a shows a cocktail shaker in accordance with an embodiment of the present disclosure;

FIG. 1b shows an exploded transparent view of a lid of the cocktails shaker in accordance with an embodiment of the present disclosure;

FIG. 1c shows an exploded solid view of the lid shown in FIG. 1b;

FIG. 1d shows an assembled view of the lid shown in FIG. 1c;

FIG. 1e schematically shows a perspective view of an inclined wall that joins the opening;

FIG. 1f schematically shows a cross-sectional view of the inclined wall shown in FIG. 1e;

FIG. 2 shows a lid in accordance with another embodiment of the present disclosure;

FIG. 3 shows a lid in accordance with another embodiment of the present disclosure;

FIG. 4 shows a lid in accordance with another embodiment of the present disclosure;

FIG. 5 shows a lid in accordance with another embodiment of the present disclosure;

FIG. 6 illustrates each of lids in FIGS. 3 to 5 in an assembled orientation;

FIGS. 7a, 7b show a lid in accordance with another embodiment of the present disclosure,

FIGS. 8a to 8l show a lid in accordance with another embodiment of the present disclosure.

### DETAILED DESCRIPTION

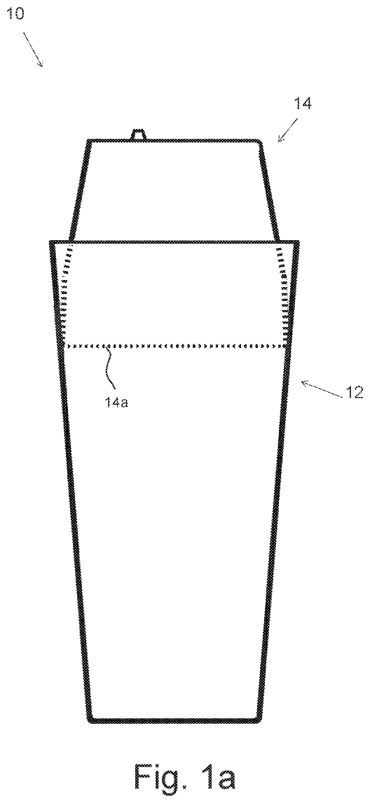

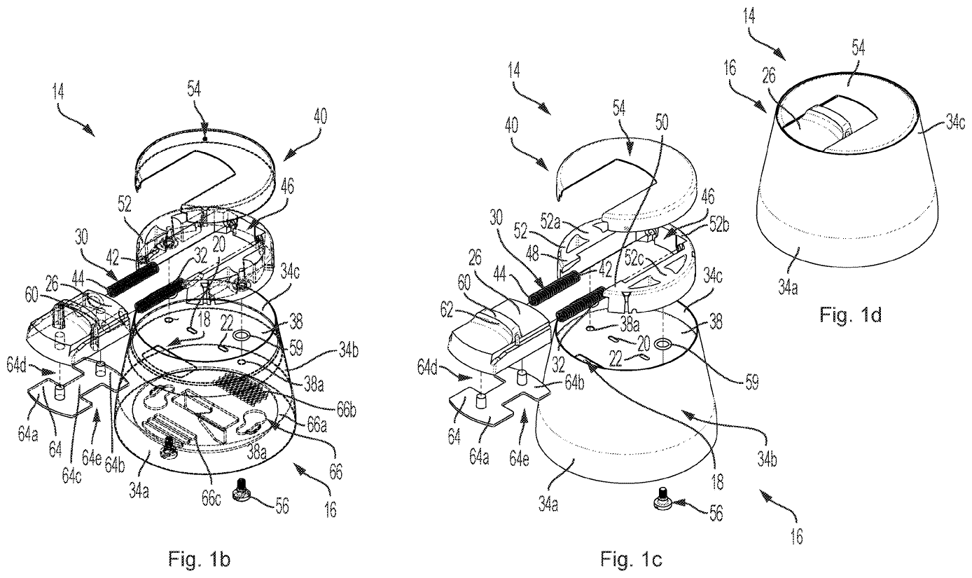

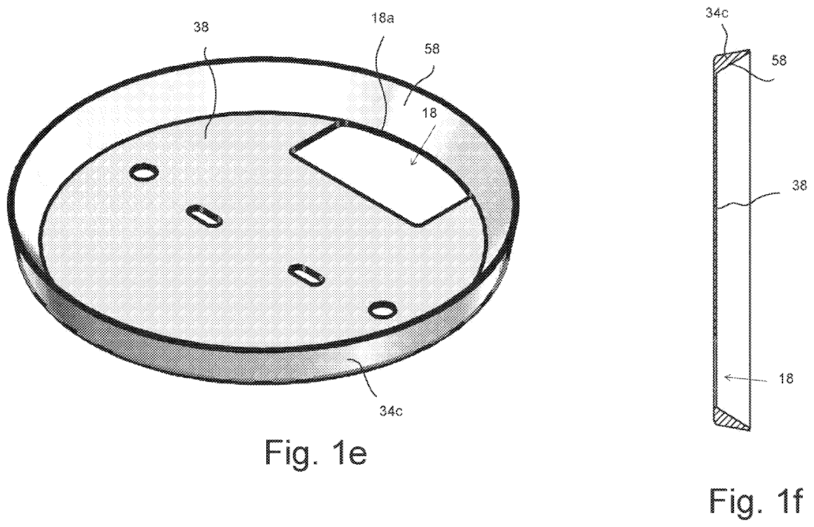

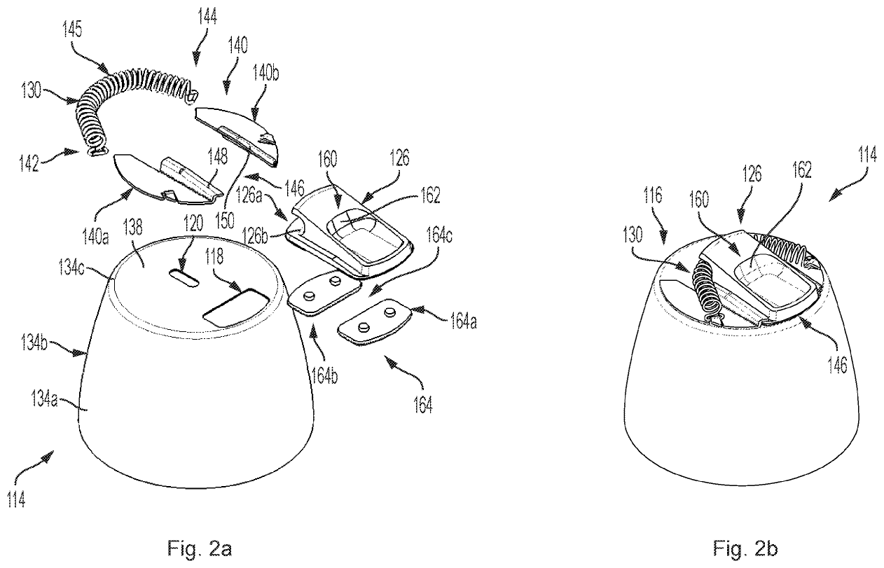

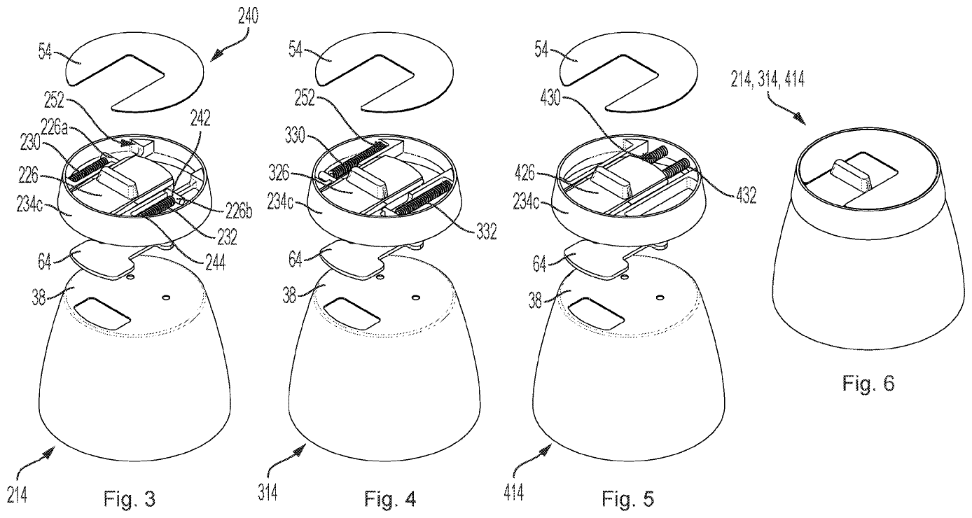

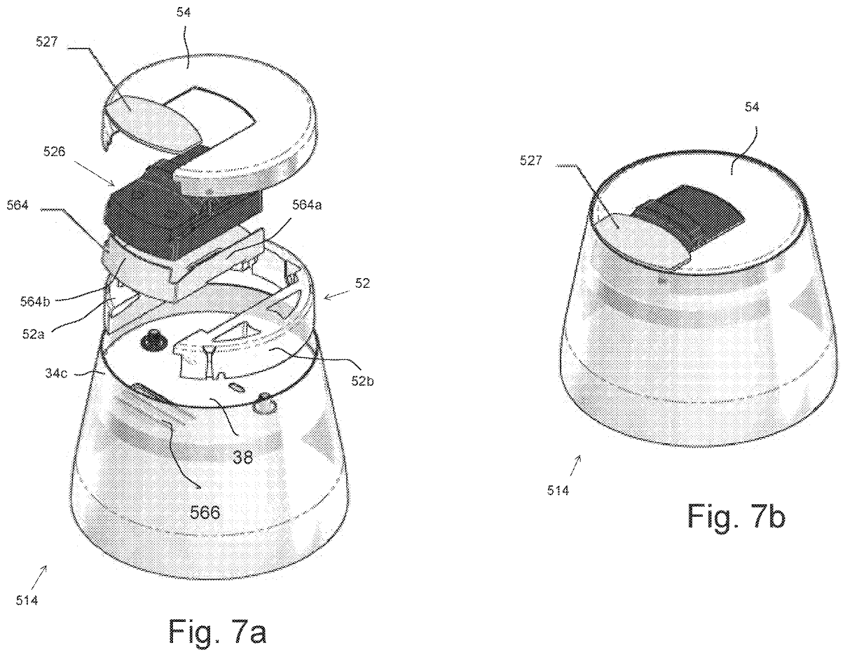

FIGS. 1a to 1e show a cocktail shaker 10 including a cup 12 for receiving liquid ingredients, and a lid 14 for installing on the cup 12. The lid 14 includes a base 16 including an opening 18 for dispensing the liquid ingredients out of the cocktail shaker 10, and at least one pressure relief hole 20, 22 for releasing air from the cup 12 while dispensing the liquid ingredients out of the cocktail shaker 10 through the opening 18. The lid 14 also includes a cover 26 movably coupled to the base 16 for moving between a first orientation in which the cover 26 covers the opening 18 and the at least one pressure relief hole 20, 22, and a second orientation in which the opening 18 and the pressure relief holes 22 are partially or fully uncovered. The lid 14 further includes at least one elastic element in the form of at least one spring 30, 32 biasing the cover 26 into the first orientation. The cover 26 is movable from the first orientation into the second orientation by overcoming the biasing by the at least one spring 30, 32.

The base 16 includes for coupling to the cup 12, an annular intermediate section 34b that extends upward from annular while tapering radially inward, and an annular upper rim 34c on top of annular intermediate section 34b. As illustrated in FIG. 1a, the annular end section 34a defines a bottom end 14a of lid 14 that can contact an inner circumferential surface of cup 12 to couple lid 14 to cup 12. The base 16 further includes a top wall 38 including the opening 18 and the at least one pressure relief hole 20, 22. The top wall 38 is recessed below the annular upper rim. The cover 26 is slidably connected to the top wall 38. The base 16 further includes a retainer 40 configured for connecting the cover 26 to the top wall 38.

A first portion of the at least one spring 30, 32, which in the embodiment shown in FIG. 1 is a first end 42 of the at least one spring 30, 32, is connected to the retainer 40 and a second portion of the at least one spring 30, 32, which in the embodiment shown in FIG. 1 is a second end 44 of the at least one spring 30, 32, is connected to the cover 26. In the embodiment shown in FIG. 1, the at least one spring 30, 32 is configured for being in an expanded orientation in the first orientation of the cover 26 and in a contracted orientation in the second orientation of the cover 26. The at least one spring 30, 32 is configured to be compressed by moving the cover 26 from the first orientation to the second orientation.

In the embodiment shown in FIGS. 1b, 1c, the cocktail shaker 10 includes a first spring 30 and a second spring 32. The first end 42 of the first spring 30 is connected to the cover 26 and the second end 44 of the first spring 30 is connected to the retainer 40. The first end 42 of the second spring 32 is connected to the cover 26 and the second end 44 of the second spring 32 is connected to the retainer 40. In other embodiments, instead of being springs, the elastic element can be one or more rubber bands.

The retainer 40 defines a slot 46 in which the cover 26 is slidable between the first orientation and the second orientation. The retainer 40 includes a first lip 48 on a first side of the slot 46 and a second lip 50 on a second side of the slot 46. The first lip 48 and second lip 50 are configured for retaining the cover 26 in the slot 46 as the cover 26 is slid between the first orientation and the second orientation.

The retainer 40 includes frame 52 and a cap 54 for being attached on top of the frame. The frame 52 includes a first section 52a defining the first side of the slot 46 and including the first lip 48, a second section 52b defining the second side of the slot 46 and including the second lip 50, and a third section 52c defining a longitudinal end of the slot 46. The cover 26 is movable toward the third section 52c when moving from the first orientation to the second orientation. The frame 52 includes a semi-circular outer perimeter when viewed from a top of the cocktail shaker 10. The semi-circular outer perimeter extends along the first section 52a, the second section 52b and the third section 52c of the frame 52. The frame 52 can be connected to top wall 38 by threaded fasteners 56 that are received in holes 38a in top wall 38. Holes 38a are surrounded by silicon o-rings 59, which are sandwiched between top wall 38 and frame 52, that prevent liquid from out of holes 38a. The cap 54 connects to the top of frame 52 and defines a top of the slot 46. In the second orientation, a portion of cover 26 closest to third section 52c can be positioned under cap 54.

As shown schematically in Figs. le, If the base 16 can include an inclined wall 58 on an annular inner surface of annular upper rim 34c. The inclined wall 58 extends upward from an edge 18a of the opening 18 and away from the top wall 38 to annular upper rim 34c. The inclined wall 58 extends directly to opening 18 from upper rim 34c without any portion of top wall 38 between inclined wall 58 and opening 18 to prevent liquid residue from collecting between the inclined wall 58 and the opening 18 after pouring a cocktail. The inclined wall 58 is at an obtuse angle with respect to the top wall 38.

Referring back to FIGS. 1b to 1d, the cover 26 is slidably connected to the top wall 38 for sliding parallel to the top wall 38. The cover 26 includes a finger grip 60 for moving the cover 26 from the first orientation to the second orientation. The bartender can move the cover 26 away from the opening 18 into the second orientation by the bartender contacting a finger pull surface 62 of finger grip 60 with tips (i.e., distal phalanx) of the bartender's index, middle and/or ring finger and/or thumb, and pulling the cover 26 in opposition to the force of the springs 30, 32.

The cover 26 includes a finger pull surface 62, which includes the finger grip 60, and a sealing gasket 64 for sealing the opening 18 and the at least one pressure relief hole 20, 22 in the first orientation. The sealing gasket 64 is attached to the bottom of the finger pull surface 62 and defines a bottom surface of the cover 26. Gasket 64 includes a first portion 64a that covers the opening 18 in the first orientation of the cover 26 and a second portion 64b that covers the at least one pressure relief hole 20, 22 in the first orientation of the cover 26. Portions 64a, 64b are connected by an intermediate portion 64c that is narrower than the portions 64a, 64b. The intermediate portion 64c is configured to define gaps between first portion 64a and portions 64b. In particular, a first gap 64d is defined between first portion 64a and portions 64b on a first side of intermediate portion 64c, and a second gap 64e is defined between first portion 64a and portions 64b on a second side of intermediate portion 64c. When the cover 26 is in the second orientation, the first gap 64d is aligned with the first pressure relief hole 20 and the second gap 64e is aligned with the second pressure relief hole 22 to allow air to flow out of the cocktail shaker 10 and through the gaps 64d, 64e while liquid is being poured out of opening 18.

The cocktail shaker 10 further includes a strainer 66 positioned below the opening 18. The strainer 66 is configured to strain out ice and other solids from the liquid ingredients upon pouring of the liquid ingredients through the strainer 66 and out of the opening 18. The strainer 66 includes a plate-shaped base 66a configured for connecting to the annular section 34a of the base 16. The plate-shape base 66a includes a plurality of holes 66b and/or slots 66c formed therein. Springs 30, 32 allow the bartender to move cover 26 to fully or partially uncover opening 18, to allow the bartender to control the flow volume out of opening 18. For example, strainer 66 can be omitted or be removable, and the bartender can strain ice or solids during pouring by only applying a lessor force, in comparison with the force required to fully uncover the opening, to partially uncover the opening 18.

A method of using the cocktail shaker 10 includes filling the cup 12 with the liquid ingredients, connecting the lid 14 on top of the cup 12, shaking the cocktail shaker 10 to mix the liquid ingredients. After the liquid ingredients are sufficiently shaken, the user (i.e., bartender) can apply a force to the cover 26 with the user's finger to move the cover 26 from the first orientation to the second orientation. The user can then pour at least some of the liquid ingredients out of the opening 18 into a glass while the cover 26 is in the second orientation. After the cocktail(s) is poured, the user can release the force applied to the cover 26 to cause the elastic element 30, 32 to move the cover 26 from the second orientation back into the first orientation.

A method of manufacturing the cocktail shaker lid 14 can include creating the base 16 defining the opening 18 for dispensing the liquid ingredients out of the cocktail shaker 10, and a at least one pressure relief hole 20, 22 for releasing air from the cup 12 while dispensing the liquid ingredients out of the cocktail shaker 10 through the opening 18. The method also includes creating the elastically loaded cover 26 that is biased into a first orientation in which the elastically loaded cover 26 covers the opening 18 and the at least one pressure relief hole 20, 22. The elastically loaded cover 26 is movable from the first orientation into a second orientation in which the opening 18 and the pressure relief holes 22 are uncovered by bartender applying a force with the bartender's finger to overcome the elastically loading.

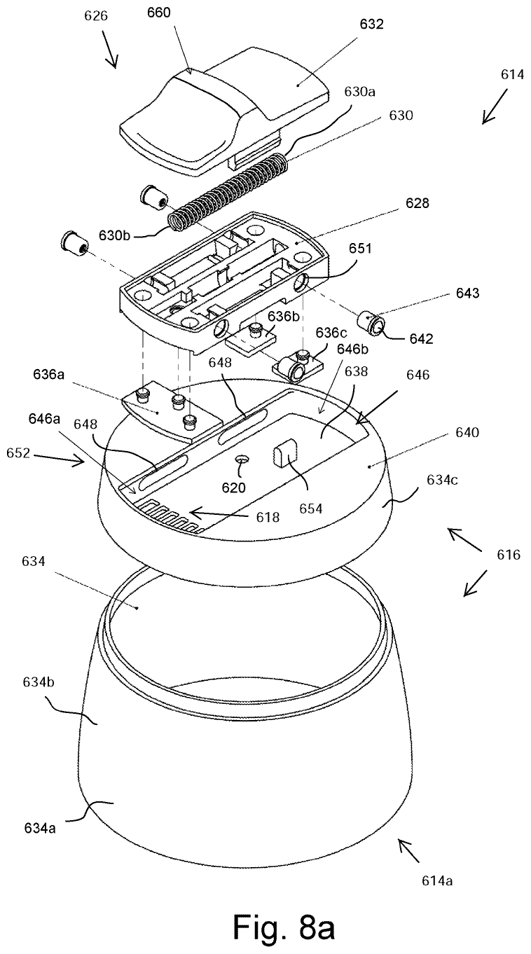

FIG. 2 shows a lid 114 in accordance with another embodiment of the present disclosure. Lid 114 includes a base 116 including an opening 118 for dispensing the liquid ingredients out of the cocktail shaker, and a pressure relief hole 120 for releasing air from the cup 12 while dispensing the liquid ingredients out of the cocktail shaker through the opening 118. The lid 114 also includes a cover 126 movably coupled to the base 116 for moving between a first orientation in which the cover 126 covers the opening 118 and the pressure relief hole 120, and a second orientation in which the opening 118 and the pressure relief hole 120 are uncovered. The lid 114 also includes a spring 130 biasing the cover 126 into the first orientation. The cover 126 is movable from the first orientation into the second orientation by overcoming the biasing by the spring 130.

The base 116 includes an annular low end section 134a for coupling to a top edge 12a of the cup 12, an annular intermediate section 134b that extends upward from annular while tapering radially inward, and an annular upper end 134c on top of annular intermediate section 134b. The base 116 further includes a top wall 138 including the opening 118 and the pressure relief hole 120. The cover 126 is slidably connected to the top wall 138. The base 116 further includes a retainer 140 configured for connecting the cover 126 to the top wall 138. The retainer 140 includes a first section 140a that is fixed to top wall 138 for example by adhesive, welding or one or more fasteners and a second section 140b spaced away from first section 140a and that is fixed to top wall 138 for example by adhesive, welding or one or more fasteners.

At least one first portion of the spring 130, which in the embodiment shown in FIG. 1 is both a first end 142 and a second end 144 of the spring 130, is connected to the retainer 140 and a second portion of the spring 130, which in the embodiment shown in FIG. 2 is a middle portion 145 of the spring 130, is connected to the cover 126. More specifically, the first end 142 of spring 130 is fixed to the first section 140a of retainer 140 and the second end 144 is fixed to the second section 140b of retainer 140. The middle portion 145 of spring 130 abuts a longitudinal end 126a of the cover 126 in a recess 126b of cover 126 to prevent spring 130 from moving upward and out of contact with 126.

In the embodiment shown in FIG. 2, the spring 130 is configured for being in a contracted orientation in the first orientation of the cover 26 and in an expanded orientation in the second orientation of the cover 26. The spring 130 is configured to be expanded by moving the cover 26 from the first orientation to the second orientation.

The retainer 140 defines a slot 146 between first section 140a and second section 140b in which the cover 126 is slidable between the first orientation and the second orientation. The retainer 140 includes a first lip 148 on a first side of the slot 146 and a second lip 150 on a second side of the slot 146. The first lip 148 and second lip 150 are configured for retaining the cover 126 in the slot 146 as the cover 126 is slid between the first orientation and the second orientation. The first section 140a includes the first lip 148 and the second section 140b includes the second lip 150.

The cover 126 is slidably connected to the top wall 138 for sliding parallel to the top wall 138. The cover 126 includes a finger grip 160 for moving the cover 126 from the first orientation to the second orientation. The bartender can move the cover 126 away from the opening 118 by the bartender contacting a finger pull surface 162 of finger grip 160 with tips (i.e., distal phalanx) of the bartender's index, middle and/or ring finger and/or thumb, and pulling the cover 126 in opposition to the force of the spring 130.

The cover 126 includes a finger grip 160, which includes the finger pull surface 162, and a sealing gasket 164 for sealing the opening 118 and the pressure relief hole 120 in the first orientation. The sealing gasket 164 is attached to the bottom of the finger pull surface 162 and defines a bottom surface of the cover 126. Gasket 164 includes a first portion 164a that covers the opening 118 in the first orientation of the cover 126 and a second portion 164b that covers the pressure relief hole 120 in the first orientation of the cover 126. Portions 164a, 164b are spaced from each other by a gap 164c. When the cover 126 is in the second orientation, the gap 164c is aligned with the pressure relief hole 120 a to allow air to flow out of the cocktail shaker and through the gap 164c while liquid is being poured out of opening 118. Except as described above, lid 114 is configured in the same manner as 14 and is operated and manufactured in the same manner as lid 14.

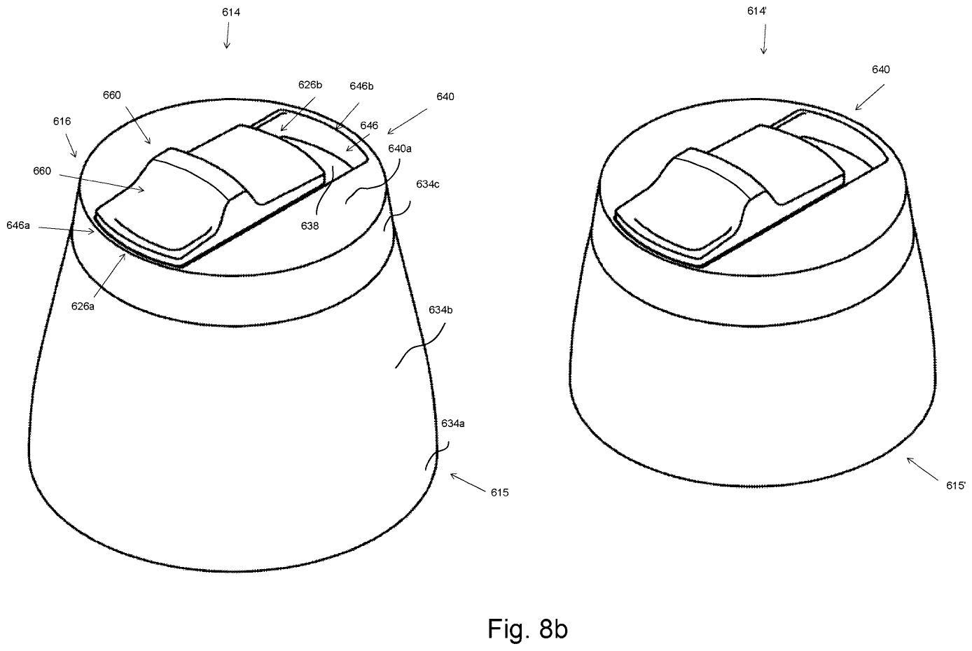

FIG. 3 shows a lid 214 in accordance with another embodiment of the present disclosure. Lid 214 is configured in the same manner as lid 14, except lid 214 includes annular upper rim 234c as part of a frame 252 of a retainer 240 instead of being formed integrally with an annular intermediate section 234b. Frame 252 and retainer 240 thus include a circular outer perimeter. Another difference is that springs 230, 232 are configured differently.

With respect to springs 230, 232, a first portion of the at least one spring 230, 232, which in the embodiment shown in FIG. 3 is a first end 242 of the at least one spring 230, 32, is connected to the retainer 240 and a second portion of the at least one spring 230, 232, which in the embodiment shown in FIG. 3 is a second end 244 of the at least one spring 230, 232, is connected to the cover 226. In the embodiment shown in FIG. 3, the at least one spring 230, 232 is configured for being in a contracted orientation in the first orientation of the cover 226 and in an expanded orientation in the second orientation of the cover 226. The at least one spring 230, 232 is configured to be expanded by moving the cover 226 from the first orientation to the second orientation. More specifically, the cover 226 includes two arms 226a, 226b protruding laterally from the cover 226, and the second end 244 of each of springs 230, 232 is connected to the respective arm 226a, 226b. The first end 242 of each of springs 230, 232 is connected to annular upper rim 234c. Except as described above, lid 214 is configured in the same manner as 14 and is operated and manufactured in the same manner as lid 14.

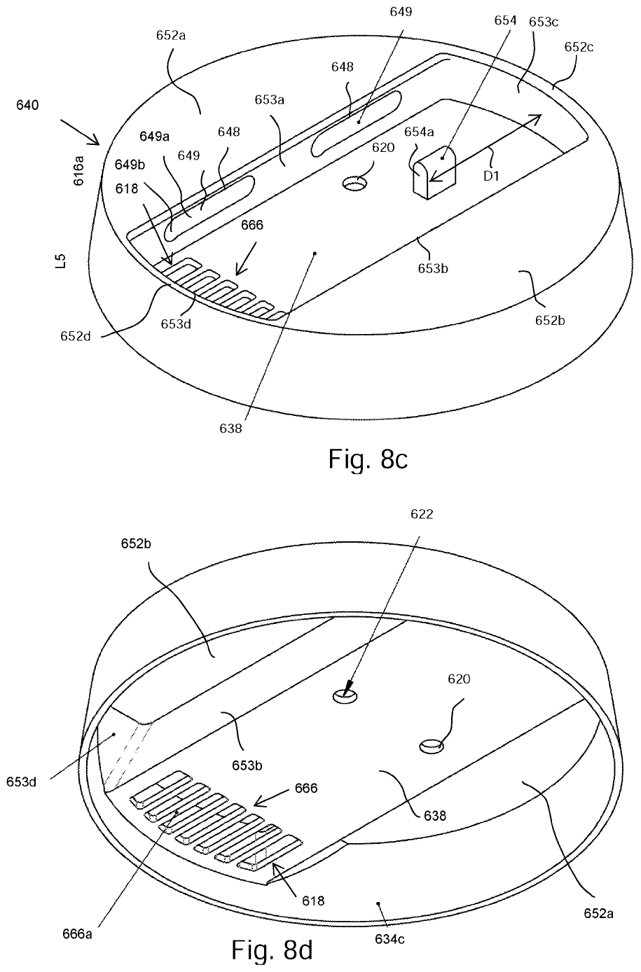

FIG. 4 shows a lid 314 in accordance with another embodiment of the present disclosure. Lid 314 is configured in the same manner as lid 214, except springs 330, 332 are configured for being in an expanded orientation in the first orientation of the cover 326 and in a contracted orientation in the second orientation of the cover 326.

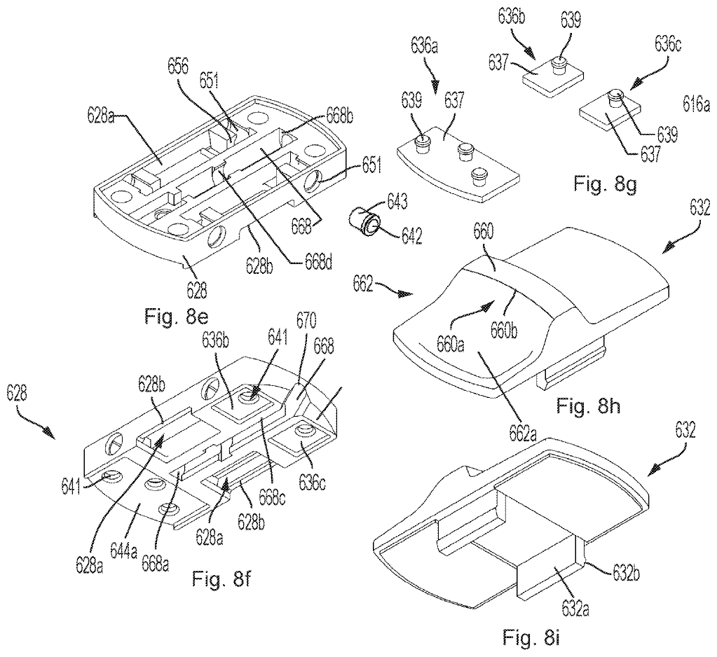

FIG. 5 shows a lid 414 in accordance with another embodiment of the present disclosure. Lid 414 is configured in the same manner as lid 314, except springs 430, 432 are attached to a longitudinal end of the cover 426, in the same manner as in FIG. 1.

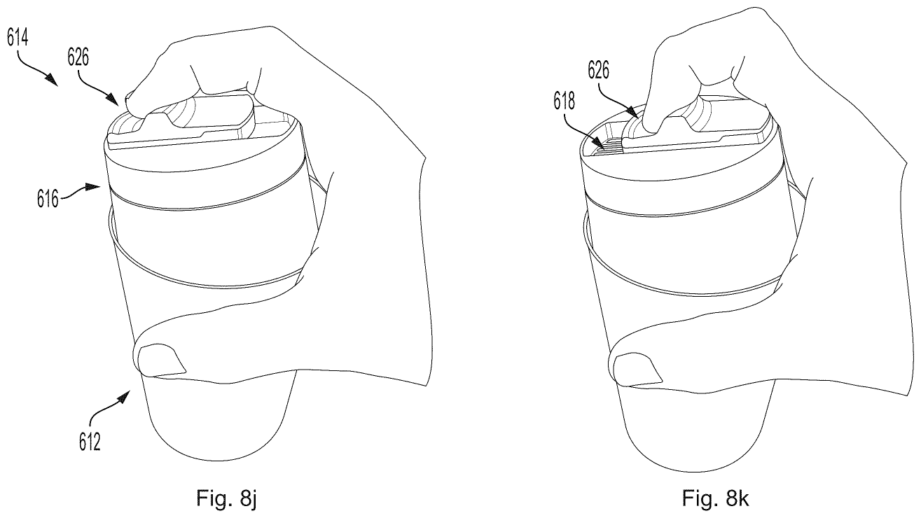

FIG. 6 illustrates each of lids 214, 314, 414 in an assembled orientation.

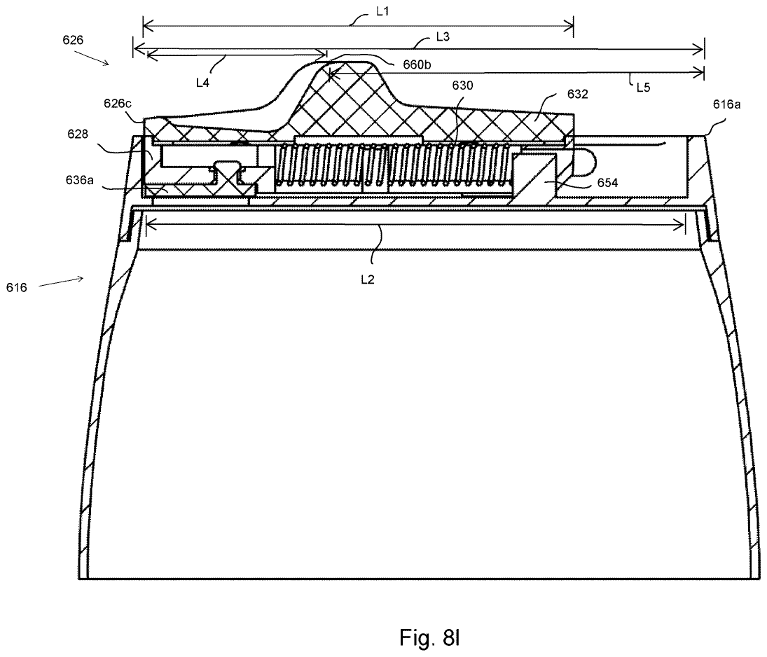

FIGS. 7a, 7b show a lid 514 in accordance with another embodiment of the present disclosure. Lid 514 is configured in the same manner as lid 14, except cover 526 includes a sealing gasket 564 and an opening 518 includes a strainer 566 formed contiguous with the top wall 38. Gasket 564 includes, in addition to the above-described features of gasket 64, side flaps 564a, and a front flap 564b. Side flaps 564a contact the respective first section 52a and second sections 52b of frame 52 to prevent liquid from flowing out of opening 18 and in between flaps 526a and the respective first section 52a and second sections 52b of frame 52. Cover 526 further includes a top gasket 527 fixed to the top of cover 526 and configured for contacting the top surface of cap 54 and the inner annular surface of annular upper rim 34c prevent liquid from flowing out of opening 18 and in between flap 564b and annular upper rim 34c.

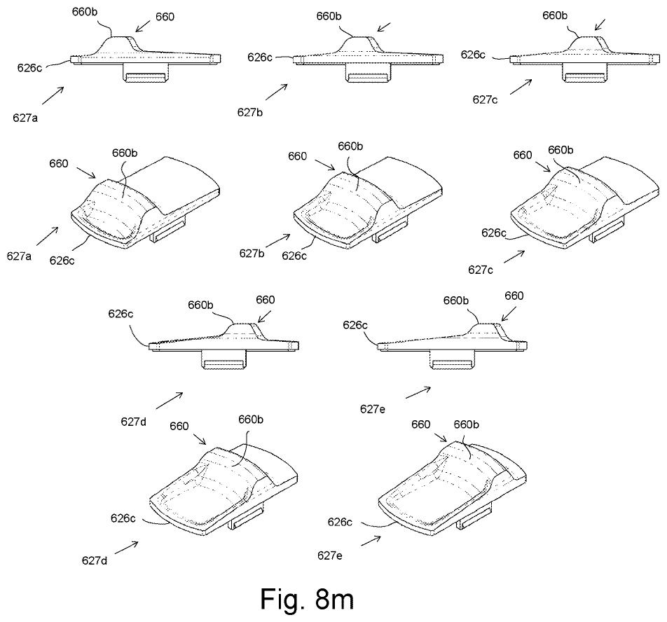

FIGS. 8a to 8e show a cocktail shaker lid 614 configured for installing on the cup 12. The lid 614 includes a base 616 including an opening 618 for dispensing the liquid ingredients out of the cocktail shaker, and at least one pressure relief hole 620, 622 (FIG. 8c) for releasing air from the cup 12 while dispensing the liquid ingredients out of the cocktail shaker through the opening 618. The lid 614 also includes a cover 626 movably coupled to the base 616 for moving between a first orientation in which the cover 626 covers the opening 618 and the at least one pressure relief hole 620, 622, and a second orientation in which the opening 618 and the pressure relief holes 620, 622 are partially or fully uncovered. The lid 614 further includes at least one elastic element in the form of a spring 630 biasing the cover 626 into the first orientation. The cover 626 is movable from the first orientation into the second orientation by overcoming the biasing by the spring 630.

The base 616 includes, for coupling to the cup 12, an annular section 634 that includes an annular lower end section 634a, an annular intermediate section 634b that extends upward from the annular end section 634a while tapering radially inward, and an annular upper rim 634c on top of annular intermediate section 634b. As illustrated in FIG. 8a, the annular end section 634a defines a bottom end 614a of lid 614 that can contact an inner circumferential surface of cup 12 to couple lid 614 to cup 12. The intermediated section 634b can having a frustoconical shape for easy of gripping base 616. The base 616 further includes a top wall 638 including the opening 618 and the at least one pressure relief hole 620, 622. The opening 618 includes a strainer 666 formed contiguous with the top wall 638. The strainer 666 is formed by a plurality of straight strips 666a traversing the opening in the longitudinal direction of the slot 646. This configuration provides a faster flow that conventional circular holes of existing cocktail shakers.

The top wall 638 is recessed below a top surface 640a of a retainer 640 configured for connecting the cover 626 to the top wall 638. The spring 630 is positioned above the top wall 630. The cover 626 is slidably connected to the top wall 638 by the retainer 640, which includes the annular upper rim 634c. Retainer 640 can be formed as a single piece, and the low and intermediate annular sections 634a, 634b are formed as a separate tubular part 615. The retainer 40 can be connected to the tubular part 615 by for example welding or screw threads. In the example shown in FIG. 8b, lid 614 is shown including a larger tubular part 615 and a smaller lid 614′ is shown including the same retainer 640 and cover 626 as lid 614, but with a smaller tubular part 615′. The tubular parts 615, 615′ can be modular and can be used with a single retainer 640 to switch from lid 614 to lid 614′. A single retainer 640 and cover 626 can thus be disconnected from larger tubular part 615, for example by unscrewing the top of larger tubular part 615 from retainer 640, and then connected to smaller tubular part 615′, for example by screwing the top of smaller tubular part 615′ onto retainer 640. This allows the retainer 640 and cover 626 to be used with cups of different sizes.

The retainer 640 defines a slot 646 in which the cover 626 is slidable between the first orientation and the second orientation. As shown in FIGS. 8c and 8d, the retainer 640 includes a frame 652 including a first section 652a defining a first longitudinally extending side of the slot 646, a second section 652b defining the second longitudinally extending side of the slot 646, a third section 652c defining a first longitudinal end of the slot 646 and a fourth section 652d defining a second longitudinal end of the slot 646. More specifically, slot 646 is defined by a first vertical side wall 653a of section 652a, a second vertical side wall 653b of section 652b, a third vertical side wall 653c of section 652c, a fourth vertical side wall 653d of section 652d and the horizontally extending top wall 638. Opening 618 is closer to fourth section 652d than to third section 652c. The cover 626 is movable toward the third section 652c and away from fourth section 652d by a user's index finger when moving from the first orientation to the second orientation, and is biased by spring 630 away from the third section 652c and toward from fourth section 652d when a force of the user's finger is released and cover 626 moves from the first orientation to the second orientation. The frame 652 includes a circular outer perimeter when viewed from a top of the lid 614. The circular outer perimeter extends along the four sections 652a to 652d of the frame 652.

As illustrated in FIG. 8c, the retainer 640 includes at least one lip 648 (two lips 648 in the embodiment shown in FIG. 8a) on first section 652a of frame 652 and at least one lip 648 on second section 652b of frame 652. The first lips 648 and second lips are configured for retaining the cover 626 in the slot 646 as the cover 626 is slid between the first orientation and the second orientation. More specifically, first lips 648 are upper edges of tracks 649 formed as grooves in vertical side wall 653a and the second lips are upper edges of tracks 649 formed as grooves in vertical side wall 653b. Each of tracks 649 includes a parallel section 649a forming a majority of the track 649 that is parallel to the upper surface of top wall 638 and a section 649b that extends downward toward top wall 638. Parallel sections 649a interact with guides 642 to cause the cover 626 to slide along top wall 638 without the bottom surfaces of the gasket portions 636a, 636b, 636c creating too much friction with top wall 638, while end sections 649b interact with guides 642 to move cover 636 downward to force gasket portion 636 a downward at the opening 618 for leakproof sealing of the opening 618, and to force gasket portions 636b, 636c downward at the pressure relief holes 620, 622 for leakproof sealing of the pressure relief holes 620, 622.

As further denoted in FIG. 8c, the retainer 640 further includes a stop 654 for contacting a first end 630a of spring 630, allowing spring 630 to be compressed by the user to force cover 626 away from the opening 618. Stop 654 extends upward from top wall 638 and includes an abutment surface 654a configured for contacting first end 630a of spring 630. Abutment surface 654a faces opening 618 and is a distance D1 from the third vertical side wall 653c.

In the embodiment shown in FIGS. 8a to 8f, the spring 630 is configured for being in an expanded orientation in the first orientation of the cover 626 and in a contracted orientation in the second orientation of the cover 626. The spring 630 is configured to be compressed by the user moving the cover 626 from the first orientation to the second orientation. During this compression of spring 630 by the user, the first end 630a of spring 630 is pressed into abutment surface 654a of stop 654 by the user's finger and a first longitudinal end 626a (FIG. 8b) of cover 626 is moved away from fourth vertical side wall 653d to uncover opening 618, while also uncovering pressure relief holes 620, 622, and a second longitudinal end 626b (FIG. 8b) of cover 626 is moved toward third vertical side wall 653c. As fourth vertical side wall 653d delimits a first longitudinal end 646a of slot 646 and third vertical side wall 653c delimits a second longitudinal end 646b of slot 646, the user compression of spring 630 causes cover 626 to move away from first longitudinal end 646a and toward second longitudinal end 646b of slot 646.

The cover 626 is slidably connected to the top wall 638 via retainer 640 for sliding parallel to the top wall 638. As shown in FIGS. 8a, 8b, the cover 626 includes a finger grip 660 for moving the cover 626 from the first orientation to the second orientation. As shown in FIGS. 8j, 8k, the bartender can move the cover 626 from the first orientation (FIG. 8j) away from the opening 618 into the second orientation (FIG. 8k) by the bartender contacting a finger pull surface 662 of finger grip 660 with tips (i.e., distal phalanx) of the bartender's index, middle and/or ring finger and/or thumb, and pulling the cover 626 in opposition to the force of the spring 630. As discussed further below with specific dimensions and shown in FIGS. 8j, 8k, the base 616 (and cup 612) can be advantageously sized to allow a base of the user's index finger to contact the outer surface of third section 652c while the distal phalanx of the user's index finger moves the cover 626 away from fourth section 652d to uncover opening 618. During this movement of the index finger, the user can grip the cup 12 with the user's thumb and pinky finger, while the ring finger and middle finger can grip the cup 12 or can grip the base 616.

As illustrated in FIGS. 8e to 8i, cover 626 can include a plurality of a pieces which are connectable together into an integrated assembly, including a carriage 628, the spring 630 (FIG. 8a) a pull section 632, and gasket portions 636a, 636b, 636c that together define the gasket of cover 626. Carriage 628 supports spring 630 and a plurality of guides 642 (FIG. 8a) configured for being received in tracks 649, allowing cover 626 to linearly slide in slot 646. Guides 642, as they are shown in FIGS. 8a, 8e, can each be balls spring-loaded inside a plunger 643 that is fixed into a respective hole 651 on longitudinally extending sides of carriage 628. To prevent liquid from collecting in holes 651, carriage 628 includes drain channels 656 extending from holes 651 to slots 628a.

Carriage 628 further includes a longitudinally extending carriage slot 668 for receiving the spring 630. Spring 630 is entirely housed within cover 626, with both of the ends 630a, 630b of spring 630 being between the first longitudinal end 626a and the second longitudinal end 626b of cover 626 in the expanded orientation of spring 630. Carriage slot 668 is delimited within carriage 628 by a stop surface 668a configured for contacting a second end 630b of spring 630 and a stop surface 668b configured for contacting first end 630a of spring 630. To prevent spring 630 from falling downward through carriage slot 668, carriage 628 includes catch surfaces 668c on opposite sides of slot 668 on which the outer circumferential surfaces of spring 630 rest with spring 630 is in carriage slot 668. Carriage 628 further includes a retainer 668d configured for spring 630 to be snapped into for limiting upward movement of spring 630 out of carriage slot 668. Carriage 628 is accordingly configured to house spring 630 in carriage slot 668 to allow compression and expansion of spring 630 in slot during operation, but to prevent spring 630 from falling out of the carriage slot 668 during operation or when cover 626 is remove from base 616. The spring 630 can be removed from carriage 628 by removing the pull section 632 and disengaging the spring 630 from retainer 668d by pulling the spring 630 upward out of the top of carriage slot 668.

When cover 626 is installed in slot 646, stop 654 is received inside of carriage slot 668 of carriage 628 in contact with the first end 630a of spring 630. When the user applies a linear force in cover 626 in the longitudinal direction of the slot 646 to move the first end 626a of cover 626 away from fourth vertical side wall 653d (i.e., to move cover 626 from the first orientation into the second orientation), the movement of cover 626 within the slot 646 causes carriage slot 668 to be moved with respect to stop 654 so that stop surface 668a moves closer to stop 654, compressing spring 630 and shortening the distance between the ends 630a, 630b of spring 630. When the linear force applied by the user in the longitudinal direction of the slot 646 is released, the spring 630 expands, lengthening the distance between the ends 630a, 630b of spring 630, causing carriage slot 668 to be moved with respect to stop 654 so that stop surface 668a moves away from stop 654.

The cover 626 includes a finger pull surface 662, which includes the finger grip 660 having a concave surface 660a shaped for mating engagement with the tip of the user's index finger. Finger pull surface 662 further includes a concave indentation 662a shaped to receive a top of the user's finger. Finger pull surface 662 is part of pull section 632, which forms the top surface of cover 626. Pull section 632 includes connectors in the form of downwardly extending clips 632a configured for removably connecting pull section 632 to the top of carriage 628. This modular design allows pull section 632 to be removed and replaced with a differently configured pull section. For example, pull section 632 can be snapped off of carriage 628, and can be replaced with a different pull section having a finger grip 660 that is closer or further from the first longitudinal end 626a of cover 626. Carriage includes two slots 628a, each configured for receiving one of the clips 632a, and two ledges 628b that prongs 632b of clips 632a snap onto. Clips 632a can be snapped off of ledges 628b to remove pull section 632 from carriage 628. Clips 632a are advantageously aligned at the center of the longitudinal direction of cover 626 so that the pull section 632 can be flipped around to configure the finger grip 660 based of the preference of the user.

FIG. 8m shows different pull sections 627a to 627e that can be used in place of pull section 632. Comparing pull sections 627a to 627e to each other, each pull sections 627a to 627e includes a finger grip 660 whose center of a top front edge 660b, i.e., a front edge of a top surface of the finger grip 660, is a different distance from the frontmost edge 626c of the respective pull section 627a to 627e. In other words, FIG. 8m shows further pull sections 627a to 627e configured for being connectable to the carriage in place of the pull section 632. The finger grip 660 of each of the further pull sections 627a to 627e is further away from or closer to a front frontmost edge 626c of the respective further pull section 627a to 627e than the finger grip 660 of the pull section 632 is from a the frontmost edge 626c of the pull section 632.

Each of gasket portions 636a, 636b, 636c, which can be formed of silicon, includes a sealing section 637 configured for contacting top wall 638 and a connector 639 configured for being inserted into a corresponding hole 641 on the bottom of carriage 628 to connect the gasket portions 636a, 636b, 636c to carriage 628. Gasket portions 636a, 636b, 636c are positioned at the corners of the lower surface of carriage 628 for optimal sliding stability and to prevent tilting of cover 626 during sliding. In particular, gasket portion 636a is positioned at the corners of the lower surface of carriage 628 at first longitudinal end 626a of cover 626, gasket portion 636b is positioned at one of the corners of the lower surface of carriage 628 at second longitudinal end 626b of cover 626 and gasket portion 636c is positioned at the other corner of the lower surface of carriage 628 at second longitudinal end 626b of cover 626.

The bottom of carriage 628 includes pads 644a, 644b, 664c that are recessed into the bottom surface of carriage 628, each shaped to receive the sealing section 637 of the respective gasket portion 636a, 636b, 636c. When installed on carriage 628, the sealing section 637 of gasket portion 636a is configured for sealingly covering the opening 618 in the first orientation of the cover 626 and the sealing section 637 of each of gasket portions 636b, 636c is configured for sealingly covering the respective pressure relief hole 620, 622 in the first orientation of the cover 626. When installed on carriage 628, portion 636a is spaced apart from portions 636b, 636c to define gaps, in the longitudinal direction of slot 646, between portion 636a and portions 636b, 636c. In particular, a first gap is defined in the longitudinal direction between portion 636a and portion 636b, and a second gap is defined in the longitudinal direction between portion 636a and portion 636c. Slots 628a are aligned with these gaps for pressure relief. When the cover 626 is in the second orientation, the slots 628a are aligned with the first pressure relief holes 620 to allow air to flow out of the cocktail shaker lid 614 and through the slots 628a at the first and second gaps while liquid is being poured out of opening 618.

By providing spring 630 within cover 626 and by providing cover 626 with guides 642, cover 626 can be easily removed from base 616 for cleaning. With cover 626 in the first orientation on base 616, the user can simply place one of the user's fingers into second longitudinal end 646b of slot 646, and lift the second longitudinal end 626b of cover 626 upward to force the spring 630 out of contact with stop 654. To aid in the lifting of the second longitudinal end 626b of cover 626, the second longitudinal end 626b of cover 626 includes an indentation 670 that is easily grippable by the user's finger. The lifting of the second longitudinal end 626b of cover 626 upward also forces the guides 642 to disengage from the respective lips 648 by moving guides 642 outside of tracks 649. Due to the spring-loading, the guides 642 are forced into carriage 628 by the lips 648. Cover 626 is thus disconnectable from base 616 by simply lifting the second longitudinal end 626b of cover 626 upward to snap the cover 626 out of the base 616. To reinstall the cover 626 back onto the base 616, the user can slide the cover 626, second longitudinal end 626b first, into slot 646 and align the carriage slot 668 on the stop 654. With the carriage slot 668 on the stop 654, the cover 626 is moved toward the second longitudinal end 646b of slot 646 to cause the first end 630a of spring 630 to contact the abutment surface 654a. The user then continues to move the cover 626 toward the second longitudinal end 646b of slot 646 until the first longitudinal end 626a of cover 626 clears fourth vertical side wall 653d, and then the first longitudinal end 626a of cover 626 is pressed downward by the user into first longitudinal end 646a of slot 646, causing the guides 642 to engage in tracks 649. Cover 626 is thus connectable to base 616 by simply aligning carriage slot 668 on stop 654 and snapping the cover 626 downward into the base 616.

FIG. 81 shows a cross-sectional side view of lid 614 along a center of lid 614, illustrating ranges of exemplary dimensions of lid 614. As shown, cover 626 has a length L1 that is advantageously between 1.0 and 2.25 inches. Slot 646 has a length L2 that is greater than the length L1 of cover 626 to allow cover to be slidable in slot 646. The length L2 of slot 646 can be between 0.25 and 1.0 inch longer than the length L1 of cover 626, and can be between 1.25 and 3.25 inches long. A maximum length L3 of the top of lid 614, measured along the center of the slot 646, can be between 1.3125 and 3.50 inches long. These lengths L1 to L3 allow a bartender to grip lid 614 with one hand and move cover 626 into the second orientation with the bartender's index finger. Also important to this functionality is the length L4 that a center of the top front edge 660b of finger grip 660 is from the frontmost edge 626c of cover 626 and/or a length L5 that a center of the top front edge 660b of finger grip 660 is from the rearmost top edge 616a of base 616. It is advantageous for easy of pulling with the bartender's finger, if length L4 is 0.25 to 1.5 inches and/or if length L5 is 1.0 to 2.25 inches. It can be further advantageous if L4 is between 0.5 and 1.0 inches and/or if L5 is between 1.5 and 2.0 inches. It can be further advantageous if L4 is between 0.6 and 0.9 inches and/or if L5 is between 1.6 and 1.9 inches.

In the preceding specification, the present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

### LIST OF REFERENCE CHARACTERS

10 cocktail shaker
12 cup
12a top edge
14 lid
14a bottom end
16 base
18 opening
18a edge
20 at least one pressure relief hole
22 at least one pressure relief hole
26 cover
30 at least one spring
32 at least one spring
34a annular end section
34b annular intermediate section
34c annular upper rim
38 top wall
38a holes
40 retainer
42 first end
44 second end
46 slot
48 first lip
50 second lip
52 frame
52a first section
52b second section
52c third section
54 cap
56 threaded fasteners
58 inclined wall
59 silicon o-rings
60 finger grip
62 surface
64 sealing gasket
64a first portion
64b portions
64c intermediate portion
64d first gap
64e second gap
66 strainer
66a plate-shaped base
66b plurality of holes
66c slots
114 lid
116 base
118 opening
120 pressure relief hole
126 cover
126a longitudinal end
126b recess
130 spring
134a annular low end section
134b annular intermediate section
134c annular upper end
138 top wall
140 retainer
140a first section
140b second section
142 first end
144 second end
145 middle portion
146 slot
148 first lip
150 second lip
160 finger grip
162 surface
164 sealing gasket
164a first portion
164b second portion
164c gap
214 lid
226 cover
226a two arms
226b two arms
230 at least one spring
232 at least one spring
234b annular intermediate section
234c annular upper rim
240 retainer
242 first end
244 second end
252 frame
314 lid
326 cover
330 springs
332 springs
414 lid
426 cover
430 springs
432 springs
514 lid
518 opening
526 cover
526a flaps
527 top gasket
564 sealing gasket
564a side flaps
564b front flap
566 strainer
612 cup
614 lid
614′ smaller lid
614a bottom end
615 larger tubular part
615′ smaller tubular part
616 base
618 opening
620 pressure relief holes
622 pressure relief holes
626 cover
626a first longitudinal end
626b second longitudinal end
626c frontmost edge
627a pull sections
628 carriage
628a slots
628b two ledges
630 spring
630a first end
630b ends
632 pull section
632a clips
632b prongs
634 annular section
634a annular end section
634b annular intermediate section
634c annular upper rim
636 cover
636a gasket portions
636b gasket portions
636c gasket portions
637 sealing section
638 top wall
639 connector
640 retainer
640a top surface
641 corresponding hole
642 guides
643 plunger
644a pads
644b pads
646 slot
646a first longitudinal end
646b second longitudinal end
648 at least one lip
649 tracks
649a parallel section
649b section
651 holes
652 frame
652a first section
652b second section
652c third section
652d fourth section
653a first vertical side wall
653b second vertical side wall
653c third vertical side wall
653d fourth vertical side wall
654 stop
654a abutment surface
656 drain channels
660 finger grip
660a concave surface
660b top front edge
662 finger pull surface
662a concave indentation
664c pads
666 strainer
666a plurality of straight strips
668 carriage slot
668a stop surface
668b stop surface
668c catch surfaces
668d retainer
670 indentation

1. A cocktail shaker comprising:
a cup for receiving liquid ingredients; and
a lid for installing on the cup, the lid including:
a base including:
a top wall;
an opening in the top wall for dispensing the liquid ingredients out of the cocktail shaker; and
a pressure relief hole in the top wall for releasing air from the cup while dispensing the liquid ingredients out of the cocktail shaker through the opening;
a cover movably coupled to the base for moving along the top wall between a first orientation in which the cover covers the opening and the pressure relief hole, and a second orientation in which the opening and the pressure relief hole are uncovered; and
an elastic element for biasing the cover into the first orientation, the cover being movable from the first orientation into the second orientation by overcoming the biasing by the elastic element,
the cup and lid being configured such that a user can grip the cup with one hand and move the cover from the first orientation to the second orientation with an index finger of the one hand.

2. (canceled)

3. The cocktail shaker as recited in claim 1, wherein the elastic element is housed within the cover.

4. The cocktail shaker as recited in claim 1, wherein the elastic element is housed entirely within the cover.

5. The cocktail shaker as recited in claim 1, wherein an entirety of the cover is above the top wall during the movement from the first orientation into the second orientation.

6. The cocktail shaker as recited in claim 1, wherein the cover is configured for being snapped on and off of the base.

7. The cocktail shaker as recited in claim 1, wherein the cover is configured such that an upward force applied by a user's finger to a longitudinal end of the cover snaps the cover off of the base.

8. The cocktail shaker as recited in claim 1, wherein the cover includes guides on sides thereof that are configured for being snapped into engagement with lips on the base.

9. The cocktail shaker as recited in claim 8, wherein the base includes a longitudinally extending slot in which the cover is movable between the first orientation and the second orientation, the slot being delimited by two longitudinally extending side walls, the lips forming parts of tracks in the two longitudinally extending side walls.

10. The cocktail shaker as recited in claim 9, wherein cover includes a gasket configured for cover the opening and the pressure relief hole in the first orientation, the tracks each including an end section configured to interact with the respective guides to move the cover downward to force the gasket downward at the opening and at the pressure relief hole.

11. The cocktail shaker as recited in claim 9, wherein the guides are coupled to the cover for being temporarily biased into the cover during the snapping of the of the guides into engagement with the lips.

12. The cocktail shaker as recited in claim 8, wherein the guides are received in holes in the cover, the holes being connected to drain channels configured for draining fluid in the holes out of a bottom of the cover.

13. The cocktail shaker as recited in claim 1, wherein the base includes a longitudinally extending slot in which the cover is movable between the first orientation and the second orientation, the cover having a length L1 that is between 1.0 and 2.25 inches, and the slot having a length L2 that between 0.25 and 1.0 inch longer than the length L1 of the cover.

14. The cocktail shaker as recited in claim 13, wherein a maximum length L3 of a top of the lid, measured along the center of the slot, is between 1.3125 and 3.50 inches long.

15. The cocktail shaker as recited in claim 13, wherein a center of a top front edge of a finger grip of the cover is a length L4 of 0.25 to 1.0 inches from a frontmost edge of the cover.

16. (canceled)

17. The cocktail shaker as recited in claim 1, further comprising a stop fixed to the top wall, the elastic element being a spring held between the cover and the stop.

18. The cocktail shaker as recited in claim 17, wherein the elastic element is configured for being in an expanded orientation in the first orientation of the cover and in a contracted orientation in the second orientation of the cover, the elastic element configured to be compressed by moving the cover from the first orientation to the second orientation and compressing the elastic element between the stop and a surface of the cover.

19. The cocktail shaker as recited in claim 1, wherein the base includes a strainer is formed by a plurality of strips traversing the opening.

20. The cocktail shaker as recited in claim 1, wherein the cover includes:
a pull section including a finger grip for the index finger of the user to move the cover from the first orientation to the second orientation; and
a carriage, the pull section being removably connected to the carriage.

21. The cocktail shaker as recited in claim 20, further comprising a further pull section, the further pull section configured for being connectable to the carriage in place of the pull section, a finger grip of the further pull section being further away from or closer to a front longitudinal edge of the further pull section than the finger grip of the pull section is from a front longitudinal edge of the pull section.

22. (canceled)

23. A method of using the cocktail shaker as recited in claim 1, the method sequentially comprising:
filling the cup with the liquid ingredients;
connecting the lid on top of the cup;
shaking the cocktail shaker to mix the liquid ingredients;
holding the cocktail shaker with one hand applying a force to the cover with the index finger of the one hand to move the cover from the first orientation to the second orientation;
pouring at least some of the liquid ingredients out of the opening into a glass while the cover is in the second orientation; and
releasing the force applied to the cover to cause the elastic element to move the cover from the second orientation back into the first orientation.

24. A cocktail shaker lid configured for being connected to a cup for receiving liquid ingredients to form a cocktail shaker, the lid comprising:
a base including:
an opening for dispensing the liquid ingredients out of the cocktail shaker; and
a pressure relief hole for releasing air from the cup while dispensing the liquid ingredients out of the cocktail shaker through the opening;
a cover movably coupled to the base for moving between a first orientation in which the cover covers the opening and the pressure relief hole, and a second orientation in which the opening and the pressure relief hole are uncovered; and
an elastic element biasing the cover into the first orientation, the cover being movable from the first orientation into the second orientation by overcoming the biasing by the elastic element,
the lid being configured such that a user can grip the lid with one hand and move the cover from the first orientation to the second orientation with an index finger of the one hand.
